(19) United States
(12) Patent Application Publication
(10) Pub. No.: US 2026/0291042 A1
(43) Pub. Date: Sep. 24, 2026

(54) Energy-Storage Device with Drainage System

(71) Applicant: BAYERISCHE MOTOREN WERKE AKTIENGESELLSCHAFT, Muenchen (DE)

(72) Inventor: Robert ALIG, Germering (DE)

(21) Appl. No.: 18/996,114

(22) PCT Filed: Sep. 8, 2023
(86) PCT No.: PCT/EP2023/074694

§ 371 Date: Jan. 17, 2025

(30) Foreign Application Priority Data
Oct. 6, 2022 (DE) 10 2022 125 809.2

(51) Int. Cl. H01M 50/691; H01M 10/613; H01M 10/625; H01M 10/6567; H01M 50/249; H01M 50/293

(52) U.S. Cl. CPC H01M 50/691; H01M 10/613; H01M 10/625; H01M 10/6567; H01M 50/249; H01M 50/293

(57) ABSTRACT

An electric energy storage device for a motor vehicle, having a storage device housing, a plurality of storage device components which are arranged in the storage device housing, a foam compound which is arranged in the storage device housing and which at least partly surrounds the storage device components, and a drainage system which is arranged in the storage device housing and is designed to convey liquid out of the foam compound, and which has at least one drainage conduit for this purpose, which is arranged in the foam compound in order to receive the liquid from the foam compound.

### BACKGROUND AND SUMMARY

This disclosure relates to an electrical energy-storage device for a motor vehicle. The electrical energy-storage device exhibits a storage housing, a plurality of storage components which are arranged in the storage housing, and a foam mass which is arranged in the storage housing and by which the storage components are at least partially surrounded. The disclosure relates, in addition, to a motor vehicle.

In the present case, interest is focused upon electrical energy-storage devices which, for instance, can be used as traction batteries for motor vehicles that are capable of being propelled electrically—that is to say, hybrid vehicles or electric vehicles. Such electrical energy-storage devices usually exhibit several storage components—for instance, interconnected storage cells, coolers, control units, sensors, etc.—which are arranged in a storage housing. It is known from the prior art, for instance from DE 10 2007 010 742 B4, to embed the storage cells in a foam material, for instance for the purpose of enhancing the mechanical stability of the electrical energy-storage device. It is problematic if the foam material is hygroscopic and becomes saturated with moisture due to condensation, for instance. This moisture may damage the storage components, for instance as a result of corrosion, a lessening of the electrical breakdown strength, a lessening of the electrical insulation, etc.

It is an object of the present disclosure to protect storage components, embedded in a foam material, of an electrical energy-storage device of a motor vehicle against moisture.

An electrical energy-storage device according to the disclosure for a motor vehicle exhibits a storage housing, a plurality of storage components which are arranged in the storage housing, and also a foam mass which is arranged in the storage housing and by which the storage components are at least partially surrounded. In addition, the electrical energy-storage device exhibits a drainage system which is arranged in the storage housing and which has been designed to convey moisture out of the foam mass and which for this purpose exhibits at least one seepage line, arranged in the foam mass, for taking up the moisture from the foam mass.

The electrical energy-storage device is, in particular, a high-voltage energy-storage device and serves as rechargeable traction battery, or traction accumulator, for an electrified motor vehicle. The electrical energy-storage device exhibits a plurality of storage components-in particular, storage cells, coolant-conducting coolers, a cell-contacting system, control units, etc. The storage cells preferably take the form of round cells. The storage components are arranged in the storage housing. The storage housing may, for instance, have been formed in two parts and may exhibit a trough-shaped lower housing part and also a trough-shaped upper housing part. The lower housing part constitutes a housing base, and the upper housing part constitutes a housing cover. A receiving space of the storage housing, in which the storage components are also arranged, has been at least partially filled with the foam material, so that the storage components are at least partially embedded in the foam material. The storage components can be held by the foam material, and a mechanical stability of the electrical energy-storage device can be enhanced.

The foam material may be, for instance, hygroscopic or open to diffusion, or may become so due to ageing. As a result, the foam may become saturated with liquid. The liquid may accumulate in the foam material as a result of direct exposure, for instance to coolant as a consequence of a leakage from the cooler, or to condensed water as a result of diffusion of air and change in dew-point as a consequence of a change in temperature. Actively cooled parts of the energy-storage device, and increases in temperature as a result of heat dissipated from storage components during the operation of the electrical energy-storage device, increase the risk of inclusions of moisture in the foam material. Since the foam material itself does not dry out well, the drainage system has been provided. This system conducts moisture away out of the foam material. For this purpose, the at least one seepage line which takes up the moisture from the foam material and transports it away, for instance to a collecting region for the liquid, arranged in the storage housing, has been embedded in the foam material. For instance, a terminal opening in the seepage line leads into the collecting region for this purpose, so that the liquid is able to flow out of the seepage line into the collecting region. The at least one seepage line—in particular, a plurality of seepage lines—is/are arranged in a critical region in the receiving space, for instance below the coolant-conducting cooler, in the vicinity of storage components that are susceptible to condensation, or such like.

For instance, between the base of the storage housing and the foam material a hollow space has been formed which is fluidically coupled with the at least one seepage line extending in the upward direction and which constitutes the collecting region for collecting the liquid conducted away out of the seepage line. A section adjacent to the housing base has accordingly not been filled with foam material, and constitutes the collecting region for the liquid. By virtue of the orientation of the at least one seepage line in the upward direction, the liquid is able to flow downward toward the housing base in accordance with gravitational force. For instance, the housing base may exhibit an outflow valve via which the liquid that has entered the collecting region from the at least one seepage line can be conducted away out of the storage housing into an environment of the energy-storage device.

The at least one seepage line may take the form of, for instance, a tube or hose, for instance consisting of a synthetic material. For the purpose of taking up the liquid from the foam material, the seepage line may be of perforated design. A jacket of the seepage line may accordingly exhibit, for instance, openings in the form of slots, gaps or holes. Via these openings, the liquid that has collected in the foam material is able to enter an interior space of the seepage line surrounded by the jacket and is able to flow away there toward the collecting region.

Such seepage lines which have been formed, in particular, from synthetic material can be produced cost-effectively in large numbers, and have a low weight. In addition, they can be arranged in the foam material particularly easily, by being inserted into the receiving space before the receiving space is filled out with foam, and by being embedded in the foam material when the receiving space is being filled out with foam.

There may also be provision that the at least one seepage line takes the form of a capillary which has been designed to at least assist the removal of the liquid through the seepage line by way of the capillary effect. In this case, an end of the seepage line located in the foam material is, in particular, of closed design. The seepage line accordingly has a capillary diameter, so that the liquid in the interior space of the seepage line can be transported by virtue of the capillary effect. As a result, in the case where the seepage line is oriented in the upward direction the removal of the liquid can be made more efficient. Alternatively, the capillary effect is also able to transport the liquid in a different direction, for instance at a right angle to the upward direction, so that the seepage line can be arranged in the foam material in arbitrarily orientated manner.

It proves to be advantageous if the electrical energy-storage device exhibits a device for generating reduced pressure, which has been designed to generate a reduced pressure in the at least one seepage line for the purpose of aspirating the liquid out of the foam material into the at least one seepage line. The device for generating reduced pressure can, for instance, be made available with the aid of a pressure-equalizing device of the electrical energy-storage device, which has been provided for pressure equalization and which is arranged in a housing wall, adjoining the collecting region, of the storage housing. In this connection, the ambient pressure—fluctuating for instance by reason of temperature, weather, altitude, dynamic pressure, etc.—is used for generating reduced pressure in the storage housing. In some embodiments, the device for generating reduced pressure can be, for example, a pump, a valve, or relief port.

The disclosure relates, in addition, to a motor vehicle exhibiting an electrical energy-storage device according to the disclosure. The motor vehicle is, in particular, an electrified motor vehicle and exhibits the electrical energy-storage device by way of traction battery.

The embodiments, and the advantages thereof, presented with reference to the electrical energy-storage device according to the disclosure apply correspondingly to the motor vehicle according to the disclosure.

Further features of the disclosure arise from the claims, from the Figure and from the description of the Figure. The features and combinations of features mentioned above in the description, as well as the features and combinations of features mentioned below in the description of the Figure, and/or shown in the Figure alone, are capable of being used not only in the respectively specified combination but also in other combinations or on their own.

### BRIEF DESCRIPTION OF THE DRAWING

FIG. 1 shows a schematic representation of a configuration of an electrical energy-storage device for a motor vehicle according to the present disclosure.

### DETAILED DESCRIPTION OF THE DRAWING

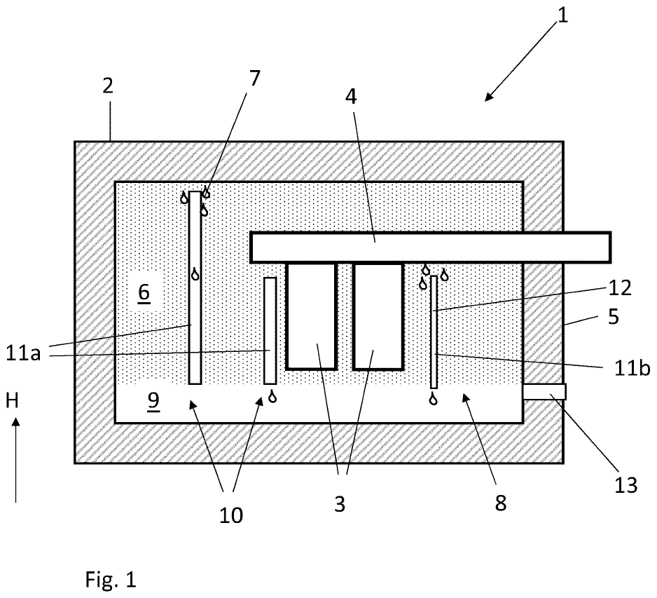

The disclosure will now be described in more detail with the aid of a preferred exemplary embodiment and also with reference to the drawing. The single Figure, FIG. 1, shows a schematic representation of a configuration of an electrical energy-storage device 1 for a motor vehicle. The electrical energy-storage device 1 exhibits a storage housing 2, in the receiving space of which several storage components 3, 4 are arranged. Storage components 3 here are storage cells-in particular, round cells- and storage component 4 is a coolant-conducting cooler (e.g., a heat exchanger) for cooling the storage cells. The cooler 4 has been passed through a wall 5 of the storage housing 2 and can be connected outside the storage housing 2 to a coolant-conducting cooling circuit of the motor vehicle. A foam material 6, which surrounds the storage components 3, 4 and, for instance, enhances a mechanical stability of the electrical energy-storage device 1, is arranged in certain regions in the receiving space.

The foam material 6 is, for instance, hygroscopic, so liquid 7 may accumulate in the foam material 6. The liquid 7 may be, for instance, condensed water or coolant which has accumulated on cooled storage components 3, 4 and which emerges from the cooler 4 by reason of a fracture of the cooler. In order to be able to route this liquid 7 out of the foam material 6 into a collecting region 8—here, a hollow space 9 between the base-side housing wall 5 and the foam material 6—the electrical energy-storage device 1 exhibits a drainage system 10. The drainage system 10 exhibits several seepage lines 11a, 11b which may take the form of, for instance, drainage tubes or drainage hoses. The seepage lines 11a, 11b are likewise embedded in the foam material 6. The seepage lines 11a, 11b extend here in an upward direction H between the base-side housing wall 5 and the cover-side housing wall 5, and lead into the collecting region 8.

The seepage lines 11a, 11b exhibit at least one opening via which the liquid 7 from the foam material 6 is able to enter the seepage lines 11a, 11b. In seepage lines 11a the liquid 7 is transported to the collecting region 8 by virtue of gravitational force contrary to the upward direction H. Seepage line 11b takes the form of a capillary 12 and transports the liquid 7 to the collecting region 8 with the aid of the capillary effect.

The electrical energy-storage device 1 exhibits, in addition, a pressure-equalizing device 13 which here is arranged in a region of the housing wall 5 that adjoins the collecting region 8. Depending upon the pressure ratios between the receiving space and an environment of the electrical energy-storage device 1, a reduced pressure which aspirates the liquid 7 may arise in the collecting region 8 and therefore in the seepage lines 11a, 11b. In this way, the transport of liquid can be made particularly efficient.

1.-8. (canceled)

9. An electrical energy-storage device for a motor vehicle, comprising:
a storage housing,
a plurality of storage components which are arranged in the storage housing,
a foam mass which is arranged in the storage housing and by which the storage components are at least partially surrounded, and
a drainage system arranged in the storage housing to convey liquid out of the foam mass, the drainage system having at least one seepage line, arranged in the foam mass, for taking up the liquid from the foam mass.

10. The electrical energy-storage device according to claim 9, wherein
the at least one seepage line is of perforated design.

11. The electrical energy-storage device according to claim 9, wherein
the at least one seepage line is a tube or hose.

12. The electrical energy-storage device according to claim 9, wherein
the at least one seepage line is a capillary to at least assist the removal of the liquid through the seepage line by way of the capillary effect.

13. The electrical energy-storage device according to claim 9, wherein
between a base of the storage housing and the foam material, a hollow space is formed which is fluidically coupled with the at least one seepage line extending in the upward direction and which constitutes a collecting region for collecting the liquid conducted away out of the seepage line.

14. The electrical energy-storage device according to claim 9, wherein
the electrical energy-storage device comprises a device for generating reduced pressure, which has been designed to generate a reduced pressure in the at least one seepage line for the purpose of aspirating the liquid out of the foam material into the at least one seepage line.

15. The electrical energy-storage device according to claim 9, wherein
at least one storage component takes the form of a coolant-conducting cooler, the at least one seepage line being arranged below the cooler and being designed to take up liquid in the form of coolant due to leakage from the cooler.

16. A motor vehicle exhibiting an electrical energy-storage device according to claim 9.
